(19) United States
(12) Patent Application Publication
(10) Pub. No.: US 2023/0222543 A1
(43) Pub. Date: Jul. 13, 2023

(54) SYSTEM AND METHOD FOR AUTOMATED GENERATION AND DISTRIBUTION OF TARGETED CONTENT TO PROMOTE USER ENGAGEMENT AND CONVERSION

(71) Applicant: WEALTHIE WORKS DAILY, INC., Toronto (CA)

(72) Inventors: Hilary Doyle, Toronto (CA); Sabaa Quao, Toronto (CA); Donald L. West, Toronto (CA)

(21) Appl. No.: 17/927,819

(22) PCT Filed: May 26, 2021
(86) PCT No.: PCT/CA2021/050713

§ 371 Date: Nov. 25, 2022

Related U.S. Application Data
(60) Provisional application No. 63/030,206, filed on May 26, 2020.

(51) Int. Cl. G06Q 30/0251; G06Q 30/0241; G09B 19/00

(52) U.S. Cl. CPC G06Q 30/0255; G06Q 30/0276; G09B 19/00

(57) ABSTRACT

A method for generating content for a ticker feed on at least one web site, wherein the method is implemented by a computer comprising a microprocessor, a computer readable medium having instructions stored thereon, the instructions executable by the microprocessor to at least: receive web site information related to at least one of content of the at least one web site having the ticker, advertisements appearing on the at least one web site, metadata; apply a predictive model to the at least one web site information to generate at least one probabilistic user profile; retrieve at least one product or service from at least one provider based on at least one probabilistic user profile; update the predictive model with user input values to refine the at least one probabilistic user profile; retrieve content for the ticker feed based on the at least one probabilistic user profile.

### FIELD

Aspects of the disclosure relate to electronic content delivery, more particularly it relates to a method and system for automated generation and distribution of targeted content for influencing online purchasing behaviour.

### BACKGROUND

Private industry spends millions of dollars every year advertising products to entice consumers to spend more, relatively little is spent in encouraging people to save and provide for their future.

In a recent study, 72% of parents reported having put their own financial security at risk for the sake of their children or dependents. It is estimated that parents in the United States spend $500 billion annually on their 18 to 34-year-old adult children, about twice the amount they contribute each year to their own retirement accounts. Nearly 75% of parents wished they had help teaching their children about investing, and 90% of parents reported that they wished that personal finances were part of the school curriculum. While there are numerous financial technology companies (fintechs) and financial institutions, many of the offered financial services overwhelmingly encourage spending, rather than saving or long-term investing.

It is an object of the present disclosure to mitigate or obviate at least one of the above-mentioned disadvantages.

### SUMMARY

In one of its aspects, there is provided a method for generating content for a ticker feed on at least one web site, wherein the method is implemented by a computer comprising a microprocessor, a computer readable medium having instructions stored thereon, the instructions executable by the microprocessor to at least:

receive web site information related to at least one of content of the at least one web site having the ticker, advertisements appearing on the at least one web site, metadata, cookie data and target pixel information;

apply a predictive model to the at least one web site information to generate at least one probabilistic user profile having a plurality of user attributes;

retrieve at least one product or service from at least one provider of the at least one product or service based on at least one probabilistic user profile;

receive input values entered by a user during a transaction involving the at least one product or service;

update the predictive model with the input values to refine the at least one probabilistic user profile;

retrieve content for the ticker feed based on the at least one probabilistic user profile; and wherein the content is provided to the ticker feed on the at least one web site.

In another of its aspects, there is provided a system for generating targeted content comprising:

at least one data source having at least one of information derived from a plurality of digital channels;
a learning module for generating at least one user profile based on information derived from the plurality of digital channels and user-input data;
a user database comprising a plurality of the at least one user profiles;
a selection engine configured to identify content for presentation to at least one user engaging with the plurality of digital channels, wherein the identified content is selected to substantially increase the likelihood of user interaction and create an interaction event;
a content module for creating content for the plurality of digital channels;
a ticker module for receiving the identified content and presenting the identified content via a ticker associated with the plurality of digital channels;
a product and service information database having a plurality of products and services available for purchase or subscription by the user;
an e-commerce module for facilitating a transaction event pertaining to purchase or subscription of at least one of the plurality of products and services and create a conversion event; and
wherein data associated with the interaction event, the transaction event and the conversion event is fed back to the learning module and selection engine to further refine the at least one user profile and identification of content for presentation to the user in a more targeted manner.

In another of its aspects, there is provided a computer-implemented savings, investment, and financial literacy platform for children and families. The platform facilitates the opening of a custodial account, such as a savings and/or an investment account, via engagement with ticker content served on a plurality of digital channels, culminating in the purchase of a product or service, such as an electronic gift card (e-gift card) that is redeemable such that the e-gift card's value is applied to the custodial account. The platform includes interactive tools for visualizing the projected asset or portfolio value of the savings or investment product over various investment periods, and thereby helps the purchaser to understand the power of compound interest, the value of starting the investment process early, and investing over a long period of time.

Advantageously, the content-targeting, data-driven selection system processes information ingested from digital channels (e.g. web sites, mobile applications (hybrid, native, web), data sets, both proprietary & public (e.g. offline event data, transactional data), user behavior (e.g., selection (e.g., click), conversion, etc.), and applies predictive models to generate probabilistic user profiles and identify content from a file storage system for display on a ticker for a specific user. Accordingly, the identified content is chosen based on the probabilistic user profile, and the identified content is deemed to be associated with the highest probability of generating both user interaction e.g. a “click” and a purchase of a product or service i.e. a conversion.

### BRIEF DESCRIPTION OF THE DRAWINGS

Several exemplary embodiments of the present disclosure will now be described, by way of example only, with reference to the appended drawings in which:

FIG. 1 shows a top-level component architecture diagram for implementing a platform for automated generation and distribution of targeted content to promote user engagement and conversion;

FIG. 2 shows an exemplary user interface;

FIGS. 3a-f show exemplary ticker feed content;

FIG. 4 shows a flowchart comprising exemplary steps for generating a user profile and providing targeted content;

FIGS. 5a-c show exemplary user interfaces corresponding to an exemplary sales conversion tool;

FIGS. 6a-c show exemplary user interfaces for consummation of a transaction;

FIG. 7 shows a graph showing the average purchase waiting time (DPC) versus the advertising awareness at consumer (VAC)/constant saturation limit (ASL); and

FIG. 8 shows an exemplary computing system.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

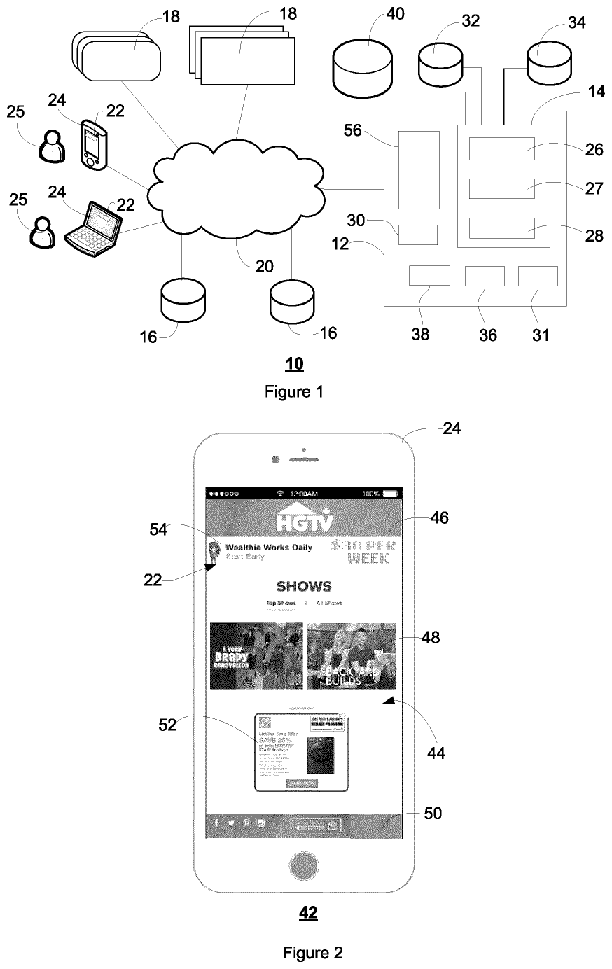

Referring to FIG. 1, there is shown a top-level component architecture diagram for implementing a system for automated generation and distribution of targeted content to promote user engagement and conversion, generally indicated by numeral 10. System 10 comprises computing device 12 with learning module 14 which receives a plurality of inputs from external data sources 16 and digital channel data sources 18 via communication network 20. Computing device 12 generates targeted content for ticker 22 appearing on the digital channels accessible on user device 24 by user 25 via communication network 20. Learning module 14 comprises artificial intelligence (AI) engine 26, analytics module 27, and selection engine 28, configured to generate a user profile based on user interactions on the digital channels, and identify content for presentation to user 25 based on the user profile. The identified content is selected to substantially increase the likelihood of user 25 interacting with ticker 22 and purchasing a product or service.

The identified content is relayed to ticker module 30 for display on ticker 22 appearing on the digital channel, such as, a social media site, social media application, a Web site, a Web application, a desktop application, a mobile application, and so forth. Any user interaction associated with ticker 22 or digital channel is reported to learning module 14 to create the user profile, and content module 31 generates content targeted toward user 25 in accordance with the user profile stored in user profile database 32. As an example, user interaction with ticker 22 on user device 24, such as a click, may cause ticker module 30 to direct user 25 to a platform where user 25 can purchase a product or service. Product and service information database 34 stores a plurality of products and services available for purchase or subscription by user 25. For example, transaction module 36 provides a transaction platform with a user interface for purchasing e-gift cards and so forth, while investment module 38 provides a user interface for facilitating the purchase of investment or products. Central database 40 stores data from digital channels 18, artificial intelligence engine 26, analytics module 27, and selection engine 28, ticker module 30, transaction module 36, and investment module 38.

In one exemplary implementation, as shown in FIG. 2, exemplary user interface 42 is displayed on user device 24, and comprises web page 44 associated with a digital channel partner or publisher. Web page 44 includes ticker 22, partner content 46, 48, 50 served by a web server associated with the digital channel partner or publisher, and advertisements 52 served by an advertising (ad) web server administered by an advertising partner or advertising platform. In operation, ticker module 30 provides ticker content 54 via a publisher's application programming interface (API) link, or ticker module 30 can be implemented with common gateway interface (CGI) scripts, or ticker module 30 can be implemented as software that runs as part of a web server process.

Ticker module 30 also provides rotational control of ticker content 54 on ticker 22, such that ticker content 54 is served at a desired frequency per day and with a desired distribution throughout the day, and that appropriate ticker content 54 is displayed on appropriate digital channel partner or publisher web site, in accordance with predetermined user demographics and user profiles. When user 25 sends a query to the web server with a request for information, the ticker module 30 causes content 54 to be served along with a response to that request, based on the user profile. Analytics module 27 analyzes information regarding user 25 engaging with ticker 22 on a web site, web application, social media site, social media application, desktop application, or mobile application, and so forth. In addition, analytics module 27 also receives any user profile information shared from the 3^{rd} party, such as a publisher or a channel partner operating the site or managing content, such as, inferences gained from tracking cookies. Selection engine 28 provides ticker content 54 that is contextually relevant to channel partner content 46, 48, 50 and in accordance with the user profile.

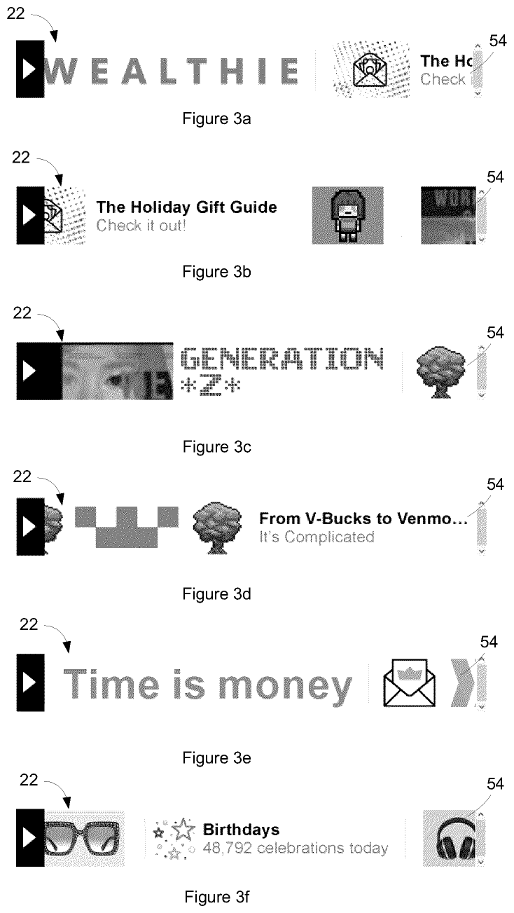

FIGS. 3a-f shows different types of ticker content 54 that is scrolled within a ticker content frame. Ticker content 54 comprises auto-curated, short, intelligent news, data, stories, games, and community content based on user profiles and user-behavioural data, and may include text, graphics, sound files, and moving images.

Ticker module 30, transaction module 36, and investment module 38 also provide logs and statistics related to user engagement with ticker 22 directly to artificial intelligence engine 24 and then to central database 40 for storage. The logs and statistics may include various statistical data, such as, what ticker content 54 was shown, how often ticker content 54 was shown, the number of times ticker content 54 was selected, who selected ticker content 54, how often the display of particular ticker content 54 has led to consummation of a transaction, etc. The log and statistics may be used by reporting module 56 to generate reports; and the reports may be used to determine if the ads are being served at the appropriate rates. and with the proper distribution throughout the day.

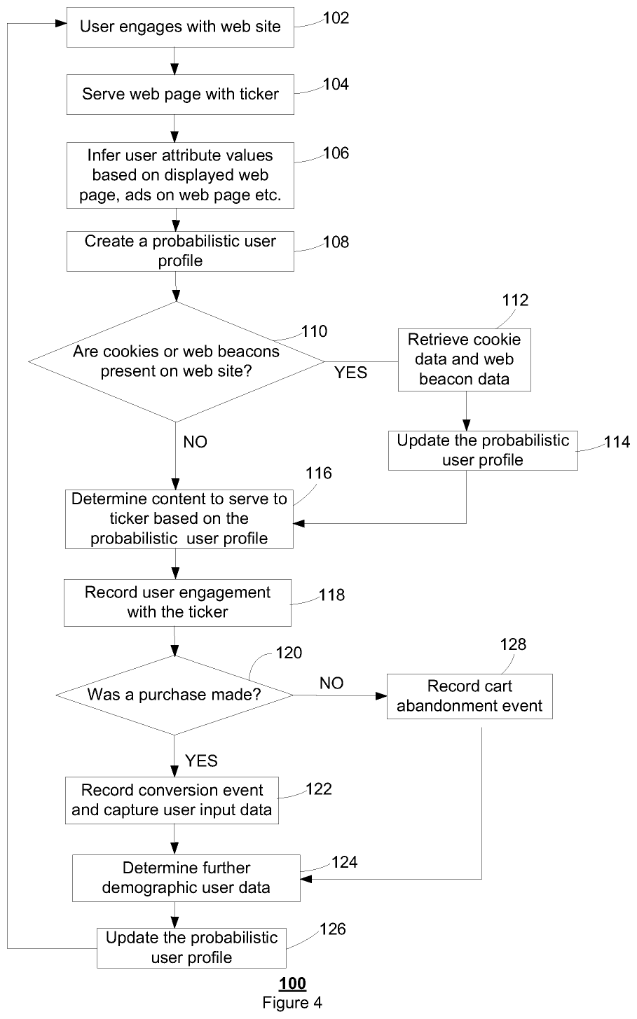

Looking at FIG. 4, there is shown flowchart 100 comprising exemplary steps for generating a user profile and providing targeted content to user 25. In step 102, user 25 engages with web page 44 from a publisher, or a channel partner via web browser. Web page 44 forms part of a web site served by a publisher, or a channel partner, that is responsible for the overall content of the web site. The browser sends a request to the publisher for content of web site served by that publisher. The digital channel partner serves the web site by providing content 46, 48, 50 for at least a portion of web page 44, and ticker 22 is caused to appear in a portion of web page 44, step 104. Given that it can be challenging to determine values for the various aspects of the user profile when user 25 has no prior profile with ticker content platform 10, in step 106 analytics module 27 receives details of the information 46, 48, 50 being displayed on web page 44, such as, titles, content, words, word count, tags, time of day, location, and ads 52 being served around ticker 22, including meta data pulled from ads 52 on the same digital asset 44 as ticker 22. In step 108, using web page 44 content details and ad 52 data, analytics module 27 generates a probabilistic user profile by inferring any of the following user attribute variables: age, interests, gender, technology level, education, family status level, hobbies, career, income, current location, previous location(s), and events attended.

Learning module 14 comprises algorithms may include deep learning models, such as machine learning models. Generally, unstructured data ingested from digital channels 18 is converted into structured data and provided machine learning algorithms as training data to generate several models to generate probabilistic user profiles, and select appropriate content targeted toward the predicted user profiles. Exemplary machine learning algorithms provides computing device with the ability to learn without being explicitly programmed, that is, the algorithms are able to learn from and make predictions on the data received from user interaction with the digital channels, user-input data from transaction events and conversion events. Accordingly, such algorithms overcome following strictly static program instructions by making data driven predictions or decisions, through building a model from sample inputs from the received input data. Learning module 14 may comprise machine learning models in any one of the following categories: (1) supervised learning, (2) unsupervised learning, or (3) reinforcement learning. Generally, deep learning employs a statistical learning method that uses multi-layered artificial neural networks to automatically learn, extract extracts features or attributes from raw data sets, and translate features from the data sets with high accuracy, without introducing traditional hand-coded code or rules.

In step 110, in an instance where the publisher uses web browser cookies or web beacons aka pixel tag to identify users 25 and thereby track the user's browsing activities, then in step 112 analytics module 27 receives the web beacon data and cookie data from the publisher or channel partner. Analytics module 27 uses the web beacon data and cookie data to gain further insights into how user 25 interacts and responds to content 46, 48, 50 on web page 44, and update the predictions of the user attribute values as more information is gathered from the user interactions across various digital channels and media, in step 114. In one example, the cookie and/or tracking pixel information includes information related to user 25, or aspects that can be reasonably inferred from cookie and/or tracking pixel information, such as location, postal code or zip code or IP address if correlated to a location, such as by using available correlators that use internet service provider and hierarchical IP addresses to approximate or pinpoint the location of user 25's internet connection. Based on the updated probabilistic user profile, selection engine 28 identifies the type of content to serve to ticker 22, wherein the identified type has the highest probability to generate a conversion event, in step 116.

If, in step 110, the publisher does not use web browser cookies or web beacons to identify users 25 and thereby track user's browsing activities, then the probabilistic user profile persists unaltered and selection engine 28 determines the type of content with the highest probability to generate a conversion event to serve to ticker 22, in step 116. Next, in step 118, user interacts with ticker 22 and the interaction event is recorded and associated data is sent to analytics module 27. In step 120, a determination is made as to whether user engagement with ticker 22 resulted in a transaction, if there was a transaction then the conversion event is recorded by transaction module 36 and investment module 38, including information inputted by user 25 in order to complete a transaction, such as, name, gender, address, contact information, credit card information, etc. in step 122. Next, in step 124 the convention event data and user-inputted is provided to analytics module 27 to update the existing probabilistic user profile, or create a brand-new user profile if the user just happened on the web site while surfing, and ended up purchasing a product or service. In step 126, based on this information, analytics module 27 may predict further information regarding user 25, such as, income level, education level, etc., and other demographic information about the purchasing user 25, and determine the purchasing user 25's relationship to the recipient of the product or service. Accordingly, analytics module 27 may determine the purchasing user 25 to be a parent, grandparent, guardian, spouse, partner, friend, aunt, uncle, etc. With the user-provided user attribute values, analytics module 27 fine-tunes the prediction mechanism and the content selection algorithms, and updates the probabilistic user profile.

Returning to step 120, if the user engagement with ticker 22 failed to result in a transaction, then the cart abandonment event is recorded by transaction module 36 and investment module 38, step 128, process proceeds to step 124 for analytics module 27 to update the existing probabilistic user profile, and analytics module 27 fine-tunes the prediction mechanism and the content selection algorithms, and updates the probabilistic user profile in step 126, and the process returns to step 102 in a iterative manner, fine-tuning the probabilistic user profile and the prediction mechanism and the content selection algorithms with each cycle.

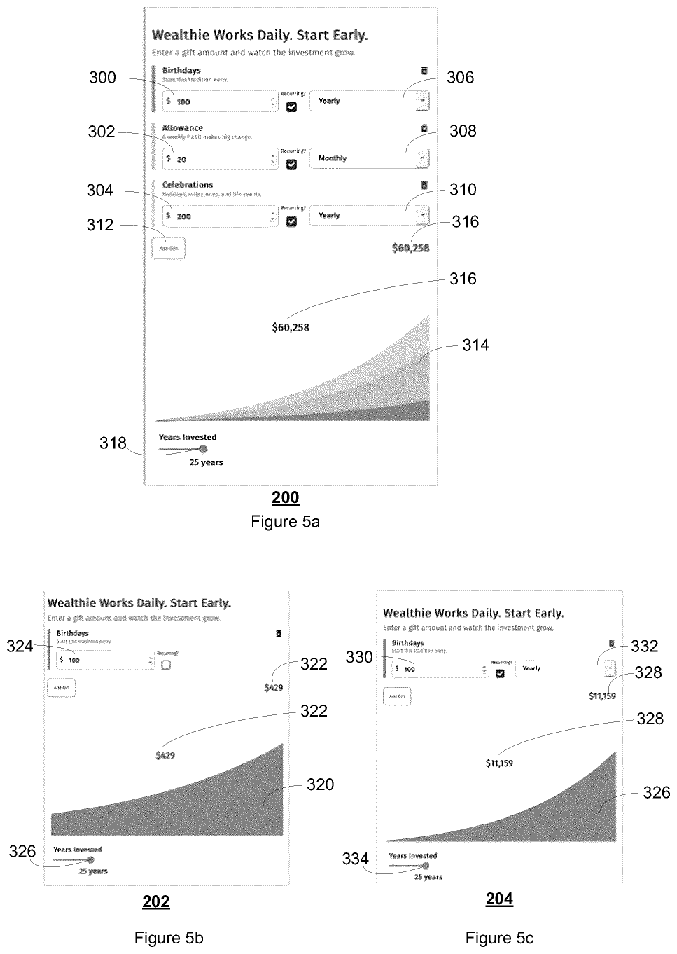

Looking at FIGS. 5a-c, there is shown exemplary user interfaces 200, 202 and 204 corresponding to exemplary sales conversion tools to influence user 25 in purchasing a product or service. In one exemplary implementation, the product is an e-gift card for purchase by user 25 for a recipient. After user clicks on ticker 22, exemplary user interface 200 is launched on device 24. As shown in FIG. 5a, user interface 200 allows user 25 to select a monetary e-gift card amount via amount field 300, 302, 304 and frequency of gifts e.g. weekly, monthly or yearly via drop-down selection menus 306, 308, 310. By selecting “Add Gift” button 312, user interface 200 shows interactive summary section 314 illustrating the projected asset or portfolio value 316 of the various e-gift cards over a period of time e.g. years selectable by slider bar 318.

As shown in FIG. 5b, user interface 202 comprises interactive summary section 320 of projected asset or portfolio value 322 of a one-time purchase of an e-gift card with a face value of $100, selected in amount field 324, over a period of time e.g. years selectable by slider bar 326. As an example, the one-time gift of $100 is estimated to have a projected value of $429 over 25 years. Meanwhile, in FIG. 5c, there is shown user interface 204 with interactive summary section 326 of projected asset or portfolio value 328 of annually recurring purchase of an e-gift card with a face value of $100, selected in amount field 330, over a period of time e.g. years selected in frequency field 332, selectable by slider bar 334. As an example, the annual recurring gift of $100 is estimated to have a projected value of $11,159 over 25 years. By comparing the projected asset or portfolio value 322 of the one-time purchase of the e-gift card to the projected asset or portfolio value 328 of an annually recurring purchase of an e-gift card, user 25 is able to understand the power of compound interest, the value of starting the investment process early, and the wisdom of investing over a long period of time. Other graphical representations of the projected asset value or portfolio may include pie charts, bar graphs, line graphs, Venn diagrams, etc. or combinations thereof.

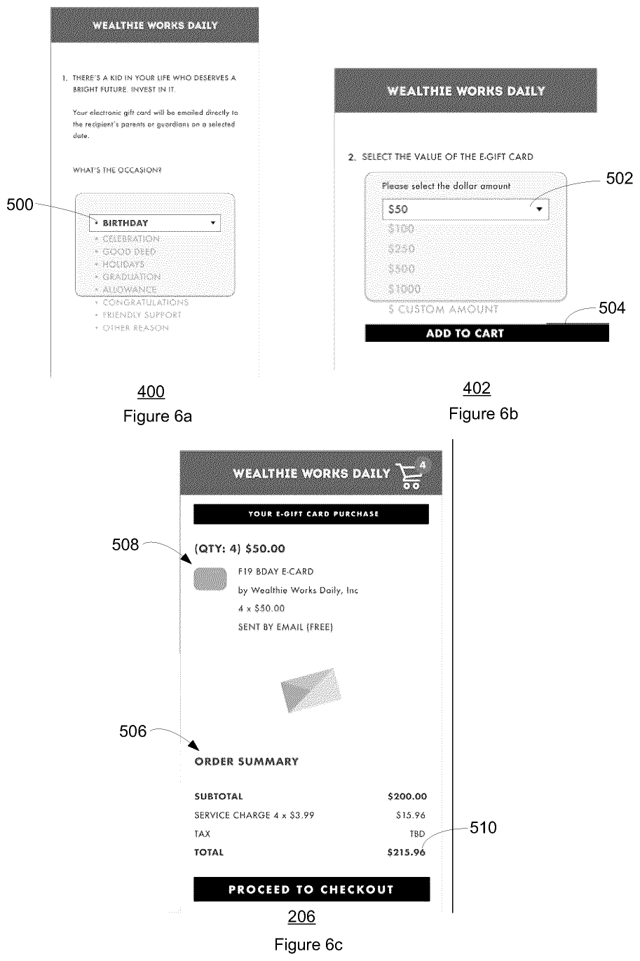

Looking at FIGS. 6a-c, there is shown exemplary user interfaces 400, 402, 404 and 406 for consummation of a transaction. User interface 400 in FIG. 6a shows drop-menu 500 for selection of the reason for an e-gift card, such as “Birthday”, “Graduation”, “Allowance”, “Other reason”, and so forth. User interface 402 in FIG. 6b shows drop-menu 502 for selection of the value of the e-gift card, such as, “$50”, “$100”, “Custom amount”, and so forth, and may also include quantities (not shown) of the e-gift card. Actuating “Add to Cart” button 504 launches user interface 404 which provides order summary 506 with details 508 of the selected e-gift card in the shopping cart and the order amount 510. User 25 may edit the contents of the shopping cart. Actuating “Proceed to Checkout” button 512 launches a payment user interface (not shown), where user 25 may enter personal details e.g. name, address, telephone number, email address, payment details e.g. credit card information, digital wallet, or crypto wallet. Following the purchase of the e-gift card, user 25 is prompted to open a custodial investment account for the recipient by entering the details of the recipient e.g. name, address, telephone number, email address, relationships, etc. Next, user 25 chooses one of a plurality of investment vehicles, such as a risk-adjusted investment vehicle, and the face value of the e-gift card is applied to the selected investment vehicle. All subsequent e-gift cards purchases are transferred directly into that account, and the investments are preferably secured within a trusted and insured partner banking institution.

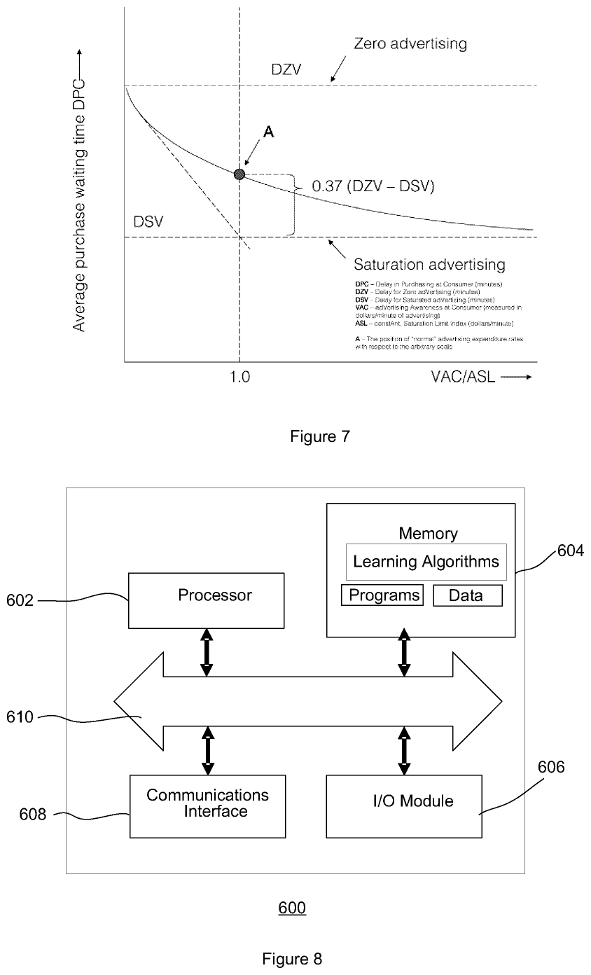

In another exemplary implementation, learning module 14 determines an optimal advertising spend based on the generated probabilistic user profile by iteratively determining whether the conversion rate meets a predefined conversion goal or a predefined conversion goal range. Generally, as spend increases to create awareness of the product or service, the average purchase waiting time decreases, and as a saturation point is reached, increasing spend does not lead to a lift in purchase time. Learning module 14 therefore may specify the optimal advertising expenditure rate to minimize delay in purchasing at consumer (DPC) through feedback loops between artificial intelligence engine 26, analytics module 27, and selection engine 28, ticker module 30, transaction module 36, and investment module 38. FIG. 7 shows a graph showing the average purchase waiting time (DPC) versus the advertising awareness at consumer (VAC)/constant saturation limit (ASL).

FIG. 8 shows computing system 600 of exemplary computing device 12. Computing system 600 comprises at least one processor such as processor 602, at least one memory 604, input/output (I/O) module 606 and communication interface 608. Although computing system 600 is depicted to include only one processor 602, computing system 600 may include more than one processor therein. In one exemplary implementation, memory 604 is capable of storing instructions. Further, the processor 602 is capable of executing instructions.

In one exemplary implementation, processor 602 may be embodied as a multi-core processor, a single core processor, or a combination of one or more multi-core processors and one or more single core processors. For example, processor 602 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, Application-Specific Standard Products (ASSPs), System-on-a-chip systems (SOCs), Complex Programmable Logic Devices (CPLDs), Graphics Processing Units (GPUs), and the like. For example, some or all of the device functionality or method sequences may be performed by one or more hardware logic components.

Memory 604 may be embodied as one or more volatile memory devices, one or more non-volatile memory devices, and/or a combination of one or more volatile memory devices and non-volatile memory devices. For example, memory 604 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY™ Disc), and semiconductor memories (such as mask ROM, PROM (programmable ROM), EPROM (erasable PROM), flash ROM, RAM (random access memory), etc.).

I/O module 606 is configured to facilitate provisioning of an output to a user of computing system 600 and/or for receiving an input from the user of computing system 600. I/O module 606 is configured to be in communication with processor 602 and memory 604. Examples of the I/O module 606 include, but are not limited to, an input interface and/or an output interface. Some examples of the input interface may include, but are not limited to, a keyboard, a mouse, a joystick, a keypad, a touch screen, soft keys, a microphone, and the like. Some examples of the output interface may include, but are not limited to, a microphone, a speaker, a light emitting diode display, a thin-film transistor (TFT) display, a liquid crystal display, an active-matrix organic light-emitting diode (AMOLED) display, and the like. In one exemplary implementation, processor 602 may include I/O circuitry configured to control at least some functions of one or more elements of I/O module 606, such as, for example, a speaker, a microphone, a display, and/or the like. Processor 602 and/or the I/O circuitry may be configured to control one or more functions of the one or more elements of I/O module 606 through computer program instructions, for example, software and/or firmware, stored on a memory, for example, the memory 604, and/or the like, accessible to the processor 602.

Communication interface 608 enables computer device 12 to communicate with other entities over various types of wired, wireless or combinations of wired and wireless networks, such as for example, the Internet. In one exemplary implementation, the communication interface 608 includes transceiver circuitry configured to enable transmission and reception of data signals over the various types of communication networks 20. In another exemplary implementations, communication interface 608 may include appropriate data compression and encoding mechanisms for securely transmitting and receiving data over communication networks 20. Communication interface 608 facilitates communication between computing system 600 and I/O peripherals.

In one exemplary implementation, various components of computing system 600, such as processor 602, memory 604, I/O module 606 and communication interface 608 may be configured to communicate with each other via or through centralized circuit system 610. Centralized circuit system 610 may be various devices configured to, among other things, provide or enable communication between the components (602-608) of computing system 600. In one exemplary implementation, centralized circuit system 610 may be a central printed circuit board (PCB) such as a motherboard, a main board, a system board, or a logic board. Centralized circuit system 610 may also, or alternatively, include other printed circuit assemblies (PCAs) or communication channel media.

In one exemplary implementation, processor 602 may be configured to execute hard-coded functionality. In one exemplary implementation, processor 602 may be embodied as an executor of software instructions, wherein the software instructions may specifically configure processor 602 to perform algorithms and/or operations described herein.

Data store 32, 34, or 40 may store content and data relating to, and enabling, operation of the ticker content generating platform, as digital data objects including content objects. A data object, in a particular implementation, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), etc. Logically, data store 32, 34, or 40 corresponds to one or more of a variety of separate or integrated databases, such as relational databases and object-oriented databases, that maintain information as an integrated collection of logically related records or files stored on one or more physical systems. Structurally, data store 32, 34, or 40 may generally include one or more of a large class of data storage and management systems. In particular implementations, data store 32, 34, or 40 may be implemented by any suitable physical system(s) including components, such as one or more database servers, mass storage media, media library systems, storage area networks, data storage clouds, and the like. In one exemplary implementation, data store 32, 34, or 40 includes one or more servers, databases e.g., a relational database like IBM DB2, Oracle 9, MySQL, and SQLite, or non-relational databases, NoSQL databases, and any suitable database associated with other database architectures, and/or data warehouses.

Databases 32, 34, 40, including database schemas, may be designed to maximize the storage space available for the data to be stored, which may account for both the quality and quantity of data. Databases 32, 34, 40 may also be optimized for rapid data retrieval. The database schema may provide a description of a structure of databases 32, 34, 40, such as definitions of the tables, fields in each table and relationships between the fields and tables. Queries to databases 32, 34, 40, may be designed based on the database schema. The database schema may include a plurality of data sources 16, each data source including one or more fields for storing data, and metadata defining relationships amongst the fields. A schema parser may determine one or more datasets of the data from the database schema, wherein a dataset includes one or more fields from a data source of the database schema and represents the data corresponding to the one or more fields.

In one exemplary implementation, the functionality hosted by computing device 12 may include web or HTTP servers, FTP servers, as well as, without limitation, web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), and the like.

In one exemplary implementation, user device 24 comprises a microprocessor with one or more processing elements (programmable or hardwired), a computer-readable medium which may include memory cache, non-volatile memory (NVM), read-only memory (ROM), and/or random-access memory (RAM), static RAM. The memory stores program code and data and the microprocessor executes the program code and processes the data. In one exemplary implementation, a non-volatile memory may be used for persistent storage and a volatile memory may be used for execution of the program code and data at runtime. Moreover, memory may be integrated within microprocessor or may be coupled to microprocessor via a bus or communication fabric, such a system bus for fast memory access, and a peripheral bus for reduced complexity and low-power consumption.

User device 24 comprises other peripheral devices such as multiple physical hardware interfaces (PHYs) for radio transceivers compatible with CDMA/CDMA2000, GSM/EDGE, GPRS, LTE, 5G, or other air interfaces used for mobile telephony. In some implementations, user device 24 described herein may support other, air interfaces, which may include one or more of IEEE 802.11a/b/g/n/ac or IEEE 802.16 (WiMAX), ZigBee, Bluetooth, or other radio frequency protocols. Other interfaces include RS-232 interface, or USB interface.

It is noted that various example embodiments as described herein may be implemented in a wide variety of devices, network configurations and applications.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, server computers, minicomputers, mainframe computers, and the like. Accordingly, system 10 may be coupled to these external devices via the communication, such that system 10 is controllable remotely. Embodiments may also be practiced in distributed computing environments where tasks are performed by local and remote processing devices that are linked (either by hardwired links, wireless links, or by a combination thereof) through communications network 20. In a distributed computing environment, program modules may be located in both local and remote memory storage devices.

In another exemplary implementation, system 10 follows a cloud computing model, or Infrastructure-as-a-service (IaaS) model, by providing an on-demand network access to a shared pool of configurable computing resources (e.g., servers, storage, applications, and/or services) that can be rapidly provisioned and released with minimal or nor resource management effort, including interaction with a service provider, by a user (operator of a thin client). Exemplary cloud computing platforms include Amazon Web Services™ (AWS), Microsoft Azure™, and Google Cloud Platform™.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments are described above with reference to block diagrams and/or operational illustrations of methods, systems, and computer program products. The operations/acts noted in the blocks may be skipped or occur out of the order as shown in any flow diagram. For example, two or more blocks shown in succession may be executed substantially concurrently or the blocks may sometimes be executed in the reverse order, depending upon the functionality/acts involved. While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as exemplary embodiments.

1.-2. (canceled)

3. A method for providing a financial literacy platform accessed by a user at a user device, the method comprising:
receiving, at a processor, web page data and metadata related to at least one content on the at least one web page;
applying, at the processor, a predictive model to the web page data and metadata to generate at least one probabilistic user profile having a plurality of user attributes corresponding to the user;
determining, at the processor using the at least one probabilistic user profile, a content type associated with the highest probability of generating a conversion event;
generating, at the processor, a user interface based on the content type and the at least one probabilistic user profile;
receiving, at a network device in communication with the processor, a user interaction with a user interface of the user device;
updating, at the processor, the user interface based on the user interaction, the updated user interface comprising an investment education interface;
receiving, at the network device, one or more user input values from the user interacting with the updated user interface; and
updating the predictive model with the one or more input values to refine the at least one probabilistic user profile.

4. The method of claim 3, further comprising:
retrieving a new content for the user interface based on the at least one probabilistic profile and displaying the new content on the user interface, the updating the user interface including adding the new content to the user interface.

5. The method of claim 4, wherein the investment education interface comprises an interactive user interface, the interactive user interface based on the content type.

6. The method of claim 5, wherein the investment education interface comprises an investment education interface for a financial product or service.

7. The method of claim 6, wherein the investment education interface comprises a graphical representation.

8. The method of claim 7, wherein the financial product or service is an e-gift card;
and the investment education interface comprises a projected outcome interface for each of a plurality of options, and a corresponding graphical interface for each corresponding option.

9. The method of claim 8, wherein responsive to a selection of the plurality of options, the user is sent a custodial investment account interface for the recipient based on the selected option.

10. The method of claim 9, wherein subsequent to the creation of the custodial account using the custodial investment account interface, the investment education interface automatically selects the same custodial account.

11. The method of claim 3, wherein the predictive model is any one of: a supervised learning model, an unsupervised learning model, a reinforcement learning model.

12. A computer-implemented platform for financial literacy, the platform comprising:
a memory;
a network device;
a processor in communication with the memory and the network device, the processor configured to:
receive, web page data and metadata related to at least one content on the at least one web page;
apply, a predictive model to the web page data and metadata to generate at least one probabilistic user profile having a plurality of user attributes corresponding to the user;
determine, at the processor using the at least one probabilistic user profile, a content type associated with the highest probability of generating a conversion event;
generate, a user interface based on the content type and the at least one probabilistic user profile;
receive, a user interaction with a user interface of the user device;
update, the user interface based on the user interaction, the updated user interface comprising at least one investment education interface;
receive, one or more user input values from the user interacting with the updated user interface; and
update the predictive model with the one or more input values to refine the at least one probabilistic user profile.

13. The system of claim 3, wherein the processor is further configured to:
retrieve a new content for the user interface based on the at least one probabilistic profile and displaying the new content on the user interface, the updating the user interface including adding the new content to the user interface.

14. The system of claim 4, wherein the investment education interface comprises an interactive user interface, the interactive user interface based on the content type.

15. The system of claim 5, wherein the investment education interface comprises an investment education interface for a financial product or service.

16. The system of claim 6, wherein the investment education interface comprises a graphical representation.

17. The system of claim 7, wherein the financial product or service is an e-gift card;
and the investment education interface comprises a projected outcome interface for each of a plurality of options, and a corresponding graphical interface for each corresponding option.

18. The system of claim 8, wherein responsive to a selection of the plurality of options, the user is sent a custodial investment account interface for the recipient based on the selected option.

19. The system of claim 9, wherein subsequent to the creation of the custodial account using the custodial investment account interface, the investment education interface automatically selects the same custodial account.

20. The system of claim 12, wherein the predictive model is any one of: a supervised learning model, an unsupervised learning model, a reinforcement learning model.
